(19) United States
(12) Patent Application Publication
(10) Pub. No.: US 2004/0236920 A1
(43) Pub. Date: Nov. 25, 2004

(54) Methods and apparatus for gathering and scattering data associated with a single-instruction-multiple-data (SIMD) operation

(76) Inventor: Gad S. Sheaffer, Haifa (IL)

Correspondence Address: GROSSMAN & FLIGHT LLC, Suite 4220, 20 North Wacker Drive, Chicago, IL, 60606-6357, US

(21) Appl. No.: 10/441,479

(22) Filed: May 20, 2003

(51) Int. Cl. G06F 12/00

(52) U.S. Cl. 711/165; 711/128

(57) ABSTRACT

Methods and apparatus for gathering and scattering data associated with a single-instruction-multiple-data operation are provided. Data is gathered from a main memory, prior to a single-instruction-multiple-data (SIMD) operation on the data, by reading the data into a memory array as columns of data and reading the data out of the memory array as rows of data (or vice-versa). Similarly, after the SIMD operation, resulting data is scattered back to main memory by reading the SIMD results into the memory array as columns of data and reading the data out of the memory array as rows of data (or vice-versa). In this manner, a fast transposition of the SIMD data may occur before and/or after the SIMD operation.

### TECHNICAL FIELD

The present application relates in general to single-instruction-multiple-data (SIMD) operations and, in particular, to methods and apparatus for gathering and scattering data associated with a single-instruction-multiple-data operation.

### BACKGROUND

Many modern computers include sub-systems which operate in parallel in order to increase computational speed. For example, many processors include single-instruction-multiple-data (SIMD) operations. SIMD operations are useful when a plurality of different data points are to be operated on in the same way. SIMD operations allows one instruction operate at the same time on multiple data items. This is especially useful for software applications that process visual images or audio files. For example, a digital image may consist of millions of pixels, where each of the pixels is represented by a “red” byte, a “green” byte, and a “blue” byte. In order to increase the redness of the picture, a certain constant may be added to each of the red bytes. In other words, in this example, the single instruction is “add,” and the multiple data is a plurality of “red” bytes. What typically requires a repeated succession of instructions (a loop) can be performed in one SIMD instruction. SIMD is analogous to a drill sergeant issuing the order “About face” to an entire platoon rather than to each soldier, one at a time.

However, the multiple data points are often stored in main memory in disjoint memory locations. In addition, there may be a certain “stride” associated with the desired data. For example, pixel information may be stored in 24 bit chunks (i.e., 8 bits of red, 8 bits of green, and 8 bits of blue followed by another 8 bits of red, 8 bits of green, and 8 bits of blue, etc.). As a result, a time consuming series of instructions must be executed prior to the SIMD operation in order to gather the SIMD data. Similarly, another time consuming series of instructions is often needed after execution of the SIMD operation in order to scatter the SIMD results back to the main memory. This overhead reduces the increase in computational speed delivered by the use of SIMD instructions.

### BRIEF DESCRIPTION OF THE DRAWINGS

FIG. 1 is a high level block diagram of a computer system.

FIG. 2 is a block diagram of the scatter/gather unit illustrated in FIG. 1.

FIG. 3 is a more detailed circuit diagram of the transpose switch and a memory cell in the scatter/gather unit.

FIG. 4 is a flowchart of a process for gathering and scattering data associated with a single-instruction-multiple-data (SIMD) operation.

### DETAILED DESCRIPTION OF EXAMPLE EMBODIMENTS

Methods and apparatus for gathering and scattering data associated with a single-instruction-multiple-data operation are provided. Data is gathered from a main memory, prior to a single-instruction-multiple-data (SIMD) operation on the data, by reading the data into a memory array as columns of data and reading the data out of the memory array as rows of data (or vice-versa). Similarly, after the SIMD operation, resulting data is scattered back to main memory by reading the SIMD results into the memory array as columns of data and reading the data out of the memory array as rows of data (or vice-versa). In this manner, a fast transposition of the SIMD data may occur before and/or after the SIMD operation.

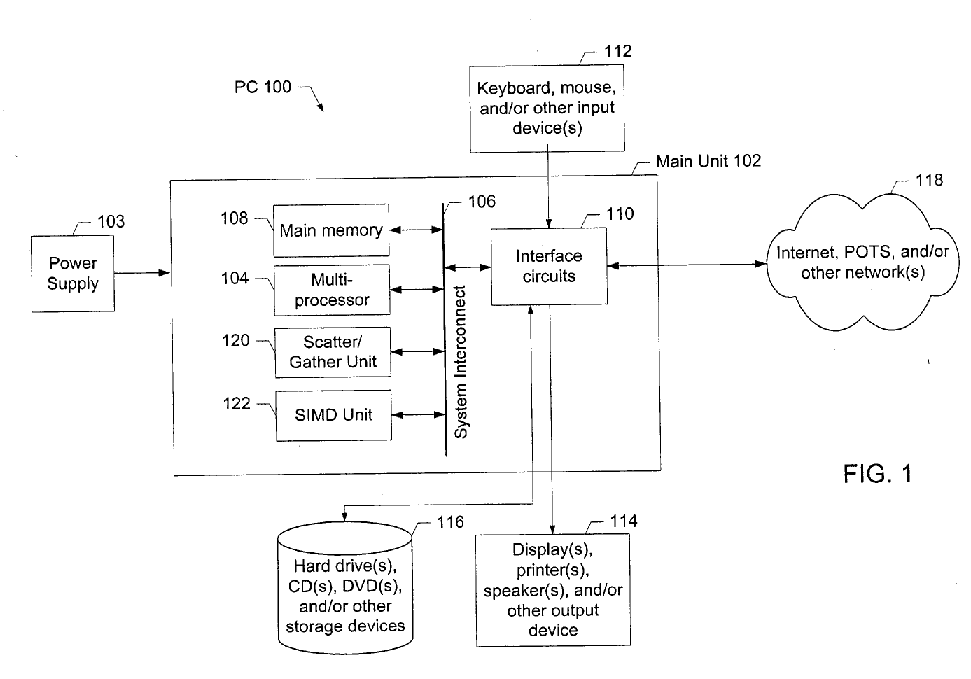

A block diagram of a computer system 100 capable of employing the scatter/gather methods and apparatus is illustrated in FIG. 1. The computer system 100 may be a personal computer (PC), a personal digital assistant (PDA), an Internet appliance, a cellular telephone, or any other computing device. In one example, the computer system 100 includes a main processing unit 102 powered by a power supply 103. The main processing unit 102 may include a multi-processor unit 104 electrically coupled by a system interconnect 106 to a main memory device 108 and one or more interface circuits 110. For example, the system interconnect 106 may be an address/data bus. Of course, a person of ordinary skill in the art will readily appreciate that interconnects other than busses may be used to connect the multi-processor unit 104 to the main memory device 108. For example, one or more dedicated lines and/or a crossbar may be used to connect the multi-processor unit 104 to the main memory device 108.

The multi-processor 104 may include any type of well known processing unit, such as a processor from the Intel Pentium™ family of microprocessors, the Intel Itanium™ family of microprocessors, and/or the Intel XScale™ family of processors. In addition, the multi-processor 104 may include any type of well known cache memory, such as static random access memory (SRAM). The main memory device 108 may include dynamic random access memory (DRAM) and/or non-volatile memory. In one example, the main memory device 108 stores a software program which is executed by the multi-processor 104 in a well known manner.

The interface circuit(s) 110 may be implemented using any type of well known interface standard, such as an Ethernet interface and/or a Universal Serial Bus (USB) interface. One or more input devices 112 may be connected to the interface circuits 110 for entering data and commands into the main processing unit 102. For example, an input device 112 may be a keyboard, mouse, touch screen, track pad, track ball, isopoint, and/or a voice recognition system.

One or more displays, printers, speakers, and/or other output devices 114 may also be connected to the main processing unit 102 via one or more of the interface circuits 110. The display 114 may be a cathode ray tube (CRTs), liquid crystal displays (LCDs), or any other type of display. The display 114 may generate visual indications of data generated during operation of the main processing unit 102. The visual displays may include prompts for human operator input, calculated values, detected data, etc.

The computer system 100 may also include one or more storage devices 116. For example, the computer system 100 may include one or more hard drives, a compact disk (CD) drive, a digital versatile disk drive (DVD), and/or other computer media input/output (I/O) devices.

The computer system 100 may also exchange data with other devices via a connection to a network 118. The network connection may be any type of network connection, such as an Ethernet connection, digital subscriber line (DSL), telephone line, coaxial cable, etc. The network 118 may be any type of network, such as the Internet, a telephone network, a cable network, and/or a wireless network.

The computer system 100 also includes a scatter/gather unit 120 and a single-instruction-multiple-data (SIMD) unit 122. The scatter/gather unit 120 and/or the SIMD unit 122 may be coupled to the processor 104 via the system interconnect 106 or a cache port (not shown). Alternatively, the scatter/gather unit 120 and/or the SIMD unit 122 may be built in to the processor 104 or connected to the computer system 100 via an interface circuit 110.

The scatter/gather unit 120 includes one or more scatter/gather arrays 202 and a plurality of memory data lines 204. The scatter/gather array 202 and the memory data lines 204 cooperate to gather input data from main memory 108 and transform the input data into a SIMD format prior to use by the SIMD unit 122. The SIMD unit 122 then performs one or more SIMD operations on the transformed input data to create SIMD output data. The scatter/gather array 202 and the memory data lines 204 also cooperate to transform the SIMD output data and scatter the transformed output data to main memory 108.

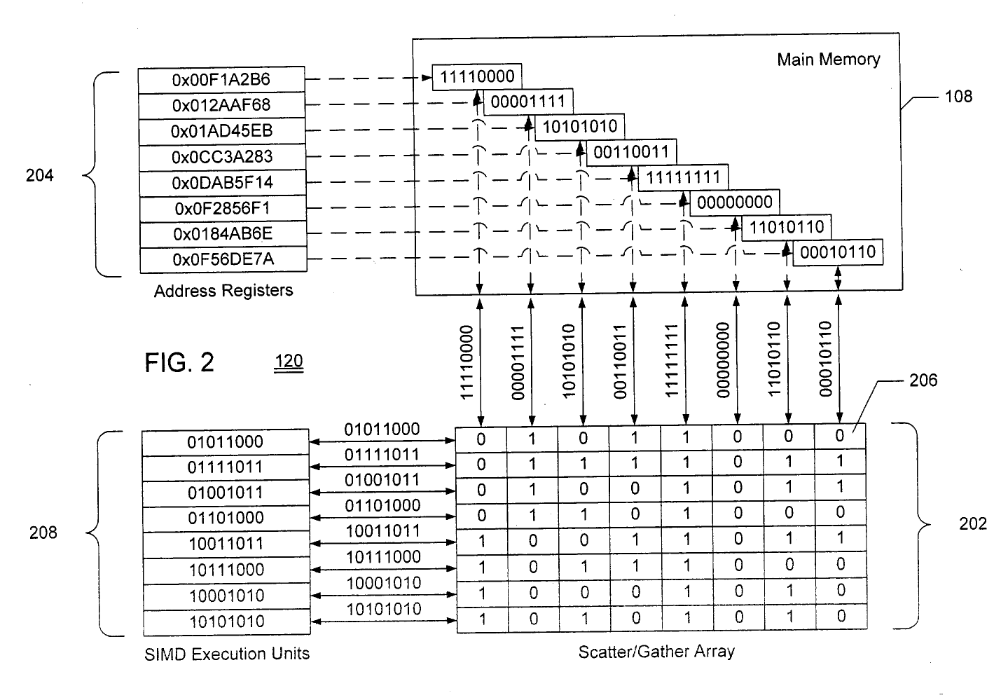

A more detailed block diagram of the scatter/gather unit 120 is illustrated in FIG. 2. The scatter/gather unit 120 includes a scatter/gather array 202 and a plurality of scatter/gather memory data lines 204. The scatter/gather array 202 includes a plurality of memory cells 206. Unlike conventional memory cell arrays, the scatter/gather array 202 is constructed to allow row-wise reads, row-wise writes, column-wise reads, and column-wise writes. Alternatively, separate scatter and gather arrays may be used. Similarly, additional scatter/gather arrays may be used to buffer data and/or perform operations in parallel. The scatter/gather memory data lines 204 point to locations in main memory 108 where SIMD input data is to be gathered from and/or where SIMD output data is to be scattered to.

The scatter/gather unit 120 is connected to the SIMD unit 122 either directly, via a source/destination bus, via the system interconnect 106, or by any other connection means. After the scatter/gather unit 120 gathers input data from main memory 108, the scatter/gather unit 120 writes the input data to the SIMD unit 122 in a SIMD format. For one example, the input data is read in to the scatter/gather array 202 as columns of data and then transferred to a plurality of SIMD execution units 208 as rows of data. Alternatively, the input data may be read in to the scatter/gather array 202 as rows of data and then transferred to the SIMD execution units 208 as columns of data. The SIMD execution units 208 may be application-specific registers and/or general purpose registers.

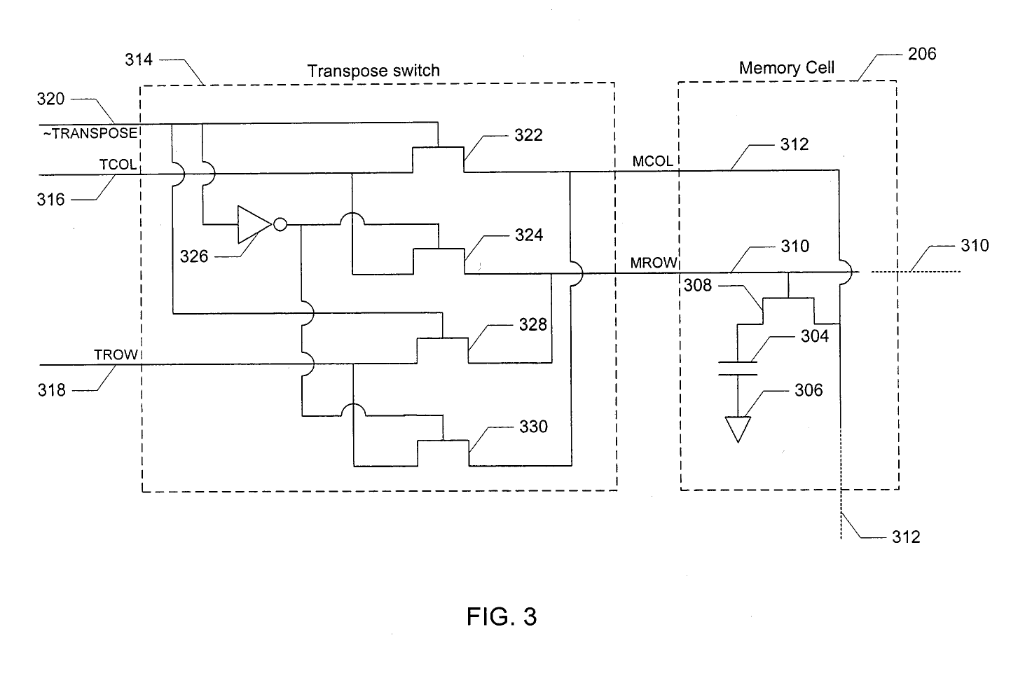

A more detailed circuit diagram of a memory cell 206 in the scatter/gather array 202 including a transpose switch is illustrated in FIG. 3. Although a dynamic random access memory cell (DRAM) is shown, a person of ordinary skill in the art will readily appreciate that any type of memory cell may be used. For example, a static random access memory (SRAM) cell may be used. The memory cell 206 illustrated includes a memory cell capacitor 304. The memory cell capacitor 304 is connected to a ground 306 and a memory cell transistor 308. The memory cell transistor 308 is connected to a memory row line 310 and a memory column line 312. Of course, additional memory cells may be connected to the memory row line 310 and/or the memory column line 312.

The memory cell capacitor 304 holds a charge indicative of a binary value. For example, a charge of approximately 0 volts (e.g., 0-2.5 V) may be indicative of a “0” value. A charge of approximately 5 volts (e.g., 2.5-5 V) may be indicative of a “1” value.

In order to write a binary value to the memory cell 206, the memory cell transistor 308 is turned on via the memory row line 310 while the memory column line 312 has an electrical potential indicative of the binary value. For example, to write a “1” to the memory cell 206, the memory column line 312 may be driven to 5 volts while the memory cell transistor 308 is turned on via the memory row line 310. As a result, the memory cell capacitor 304 is charged to approximately 5 volts. Similarly, to write a “0” to the memory cell 206, the memory column line 312 may be driven to 0 volts while the memory cell transistor 308 is turned on. As a result, the memory cell capacitor 304 is discharged to approximately 0 volts. Of course, the memory cell 206 needs to be refreshed due to leakage of the memory cell capacitor 304 as is well known.

In order to read a stored value from the memory cell 206, the memory column line 312 is driven to a midlevel voltage (e.g., 2.5V) while the memory cell transistor 308 is turned on via the memory row line 310. As a result, the memory cell capacitor 304 pulls the memory column line 312 toward the voltage of the memory cell capacitor 304. This slight voltage swing is detected by a sensing amplifier (not shown) as is well known.

In order to facilitate the gathering and scattering of data associated with an SIMD operation, the roles of the memory row line 310 and the memory column line 312 are dynamically reversible via a transpose switch 314. The transpose switch 314 includes a transpose column line 316, a transpose row line 318, and a transpose control line 320. When the transpose control line 320 is not asserted (e.g., logic high in the illustrated circuit), the transpose column line 316 is electrically connected to the memory column line 312 via a first transistor 322. However, when the transpose control line 320 is asserted (e.g., logic low in the illustrated circuit), the transpose column line 316 is electrically connected to the memory row line 310 via a second transistor 324 due to an inverter 326 connected to the transpose control line 320 and the second transistor 324.

Similarly, when the transpose control line 320 is not asserted (e.g., logic high in the illustrated circuit), the transpose row line 318 is electrically connected to the memory row line 310 via a third transistor 328. However, when the transpose control line 320 is asserted (e.g., logic low in the illustrated circuit), the transpose row line 318 is electrically connected to the memory column line 312 via a fourth transistor 330 due to the inverter 326.

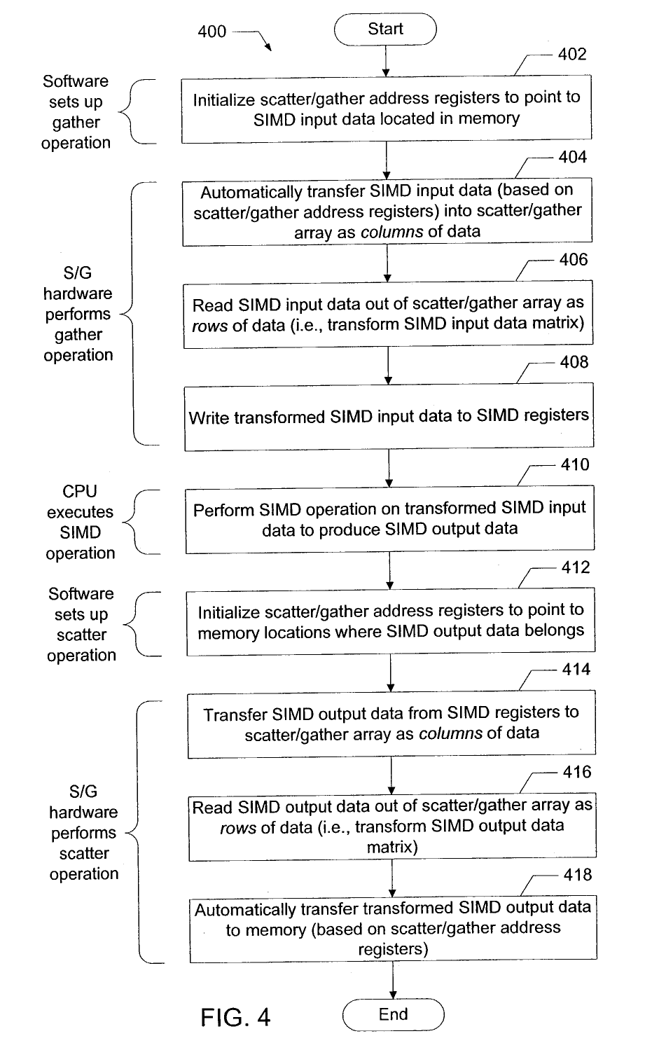

A flowchart of a process 400 for gathering and scattering data associated with a SIMD operation is illustrated in FIG. 4. Although the process 400 is described with reference to the flowchart illustrated in FIG. 4, a person of ordinary skill in the art will readily appreciate that many other methods of performing the acts associated with process 400 may be used. For example, the order of some of the operations may be changed. In addition, many of the operations described are optional, and many additional operations may occur between the operations illustrated.

The process 400 begins when a software routine being executed by the main processing unit 102 initializes the scatter/gather memory data lines 204 to point to single-instruction-multiple-data (SIMD) input data in main memory 108 (block 402). The input data may be in contiguous memory locations and/or in disjoint memory locations. Storing addresses in the scatter/gather memory data lines 204 may cause an automatic transfer of the input data into the scatter/gather array 202 as columns or rows of data (block 404). If the input data is transferred into the scatter/gather array 202 as columns of data, the input data is read out of the scatter/gather array 202 as rows of data (block 406). If the input data is transferred into the scatter/gather array 202 as rows of data, the input data is read out of the scatter/gather array 202 as columns of data. In this manner, the input data is transformed after it is read from main memory 108.

Once the input data is transformed, the transformed input data is written to the SIMD unit 122 (block 408), and the SIMD operation is performed on the data by the SIMD unit 122 to produce output data (block 410).

Subsequently, the software routine initializes the scatter/gather memory data lines 204 to point to memory locations where the output data is to be stored (block 412). The output data may be stored in contiguous memory locations and/or in disjoint memory locations. The output data is transferred from the SIMD unit 122 to the scatter/gather array 202 as columns or rows of data (414). If the output data is transferred into the scatter/gather array 202 as columns of data, the output data is read out of the scatter/gather array 202 as rows of data (block 416). If the output data is transferred into the scatter/gather array 202 as rows of data, the output data is read out of the scatter/gather array 202 as columns of data. In this manner, the output data is transformed before it is stored back in main memory 108. (418).

In summary, persons of ordinary skill in the art will readily appreciate that methods and apparatus for gathering and scattering data associated with a SIMD operation have been provided.

The foregoing description has been presented for the purposes of illustration and description. It is not intended to be exhaustive or to limit the application to the examples disclosed. Many modifications and variations are possible in light of the above teachings. It is intended that the present application be limited not by this detailed description of example embodiments, but rather by the claims appended hereto.

What is claimed is:

1. A method of gathering data for a single-instruction-multiple-data (SIMD) operation, the method comprising:
initializing a first plurality of address registers to point to SIMD input data located in a memory;
transferring the SIMD input data to a first array of registers along a first logical axis;
reading the SIMD input data out of the first array of registers along a second logical axis to produce transformed SIMD input data; and
writing the transformed SIMD input data into a plurality of SIMD registers.

2. A method as defined in claim 1, wherein transferring the SIMD input data to a first array of registers along a first logical axis comprises transferring the SIMD input data to a first array of registers as columns of data; and reading the SIMD input data out of the first array of registers along a second logical axis comprises reading the SIMD input data out of the first array of registers as rows of data.

3. A method as defined in claim 2, further comprising performing the SIMD operation on the transformed SIMD input data to produce SIMD output data.

4. A method as defined in claim 3, further comprising:
initializing a second plurality of address registers to point to destination memory locations;
transferring the SIMD output data to a second array of registers as columns of data;
reading the SIMD output data out of the second array of registers as rows of data to produce transformed SIMD output data; and
writing the transformed SIMD output data to the destination memory locations.

5. A method as defined in claim 4, wherein the first plurality of address registers comprises the second plurality of address registers.

6. A method as defined in claim 4, wherein the first array of registers comprises the second array of registers.

7. A method as defined in claim 4, wherein initializing a first plurality of address registers to point to SIMD input data located in a memory comprises initializing the first plurality of address registers to point to SIMD input data located at the destination memory locations.

8. A method as defined in claim 1, wherein transferring the SIMD input data to a first array of registers along a first logical axis comprises transferring the SIMD input data to a first array of registers as rows of data; and reading the SIMD input data out of the first array of registers along a second logical axis comprises reading the SIMD input data out of the first array of registers as columns of data.

9. A method of scattering data after a single-instruction-multiple-data (SIMD) operation, the method comprising:
initializing a first plurality of address registers to point to destination memory locations;
transferring SIMD output data to a first array of registers as columns of data;
reading the SIMD output data out of the first array of registers as rows of data to produce transformed SIMD output data; and
writing the transformed SIMD output data to the destination memory locations.

10. A method as defined in claim 9, wherein transferring SIMD output data to a first array of registers along a first logical axis comprises transferring SIMD output data to a first array of registers as columns of data, and reading the SIMD output data out of the first array of registers along a second logical axis comprises reading the SIMD output data out of the first array of registers as rows of data.

11. A method as defined in claim 10, further comprising performing an SIMD operation to produce the SIMD output data.

12. A method as defined in claim 9, wherein transferring SIMD output data to a first array of registers along a first logical axis comprises transferring SIMD output data to a first array of registers as rows of data, and reading the SIMD output data out of the first array of registers along a second logical axis comprises reading the SIMD output data out of the first array of registers as columns of data.

13. A method as defined in claim 12, further comprising performing an SIMD operation to produce the SIMD output data.

14. An apparatus comprising:
a memory cell including a memory row line and a memory column line; and
a transpose switch including a transpose row line, a transpose column line, and a transpose control line, the transpose row line being electrically coupled to the memory row line when the transpose control line is in a first state, the transpose row line being electrically coupled to the memory column line when the transpose control line is in a second state.

15. An apparatus as defined in claim 14, wherein the transpose column line is electrically coupled to the memory column line when the transpose control line is in the first state, and the transpose column line being electrically coupled to the memory row line when the transpose control line is in the second state.

16. An apparatus as defined in claim 15, further comprising a single-instruction-multiple-data (SIMD) unit coupled to the memory cell.

17. An apparatus as defined in claim 16, further comprising a first plurality of memory cells coupled to the memory row line and a second plurality of memory cells coupled to the memory column line.

18. An apparatus as defined in claim 15, wherein data is written into the apparatus as rows of data and read out of the apparatus as columns of data.

19. An apparatus as defined in claim 15, wherein data is written into the apparatus as columns of data and read out of the apparatus as rows of data.

20. An apparatus as defined in claim 16, wherein first data is written into the apparatus from a main memory as rows of data and read out of the apparatus into the SIMD unit as columns of data prior to an execution of the SIMD unit.

21. An apparatus as defined in claim 20, wherein second data is written into the apparatus from the SIMD unit as rows of data and read out of the apparatus into main memory as columns of data after the execution of the SIMD unit.

22. An apparatus as defined in claim 20, wherein second data is written into the apparatus from the SIMD unit as columns of data and read out of the apparatus into main memory as rows of data after the execution of the SIMD unit.

23. An apparatus as defined in claim 16, wherein first data is written into the apparatus from a main memory as columns of data and read out of the apparatus into the SIMD unit as rows of data prior to an execution of the SIMD unit.

24. An apparatus as defined in claim 23, wherein second data is written into the apparatus from the SIMD unit as columns of data and read out of the apparatus into main memory as rows of data after the execution of the SIMD unit.

25. An apparatus as defined in claim 23, wherein second data is written into the apparatus from the SIMD unit as rows of data and read out of the apparatus into main memory as columns of data after the execution of the SIMD unit.

26. An apparatus comprising:
a main memory;
a single-instruction-multiple-data (SIMD) unit coupled to the main memory; and
a scatter/gather hardware unit coupled to the main memory, the scatter/gather hardware unit to transpose data from the main memory to the SIMD unit.

27. An apparatus as defined in claim 26, wherein the scatter/gather hardware unit transposes data from the SIMD unit to the main memory.

28. An apparatus as defined in claim 26, wherein the main memory comprises:
a memory cell including a memory row line and a memory column line; and
a transpose switch including a transpose row line, a transpose column line, and a transpose control line, the transpose row line being electrically coupled to the memory row line when the transpose control line is in a first state, the transpose row line being electrically coupled to the memory column line when the transpose control line is in a second state.
